(19) United States
(12) Patent Application Publication
(10) Pub. No.: US 2012/0243744 A1
(43) Pub. Date: Sep. 27, 2012

(54) SECURITY ELEMENT COMPRISING A SUBSTRATE BEARING AN OPTICAL STRUCTURE AND A REFERENCE PATTERN, AND ASSOCIATED METHOD

(75) Inventors: Michel Camus, Rives Sur Fure (FR); Stéphane Mallol, Provins (FR)

(73) Assignee: Arjowiggins Security, Boulogne Billancourt (FR)

(21) Appl. No.: 13/505,081

(22) PCT Filed: Oct. 28, 2010
(86) PCT No.: PCT/IB2010/054895

§ 371 Date: Jun. 13, 2012

(30) Foreign Application Priority Data
Oct. 30, 2009 (FR) 09 57715

(51) Int. Cl. G06K 9/46

(52) U.S. Cl. 382/103

(57) ABSTRACT

The invention relates to a security element (1) which, prior to the incorporation thereof into an object, particularly a security document, comprises a substrate (6) bearing at least: an optical structure (4) producing at least one image of at least one comparison pattern and/or producing image points of a light source illuminating the optical structure; and a reference pattern (3), in which the optical structure (4) and the reference pattern (3) are borne by the substrate (6) in order to allow the simultaneous observation of an image provided by the optical structure (4) and of the reference pattern (3).

The present invention relates to security elements, particularly those for incorporation in security documents.

The expression “security document” means a means of payment, such as a banknote, a check or a restaurant voucher, an identity document, such as an identity card, a visa, a passport or a driving license, a lottery ticket, a transportation ticket or even an entrance ticket to cultural or sports events.

In order to thwart attempts to falsify or counterfeit a security document, it may be useful for the authentication and/or identification of a security element to be able to be carried out simply.

It is known how to make security elements with lens arrays associated with specific prints, in order to produce movement, depth and/or stereoscopic effects. Such products are sold by SECURENCY under the MOTION® trade mark.

Such security elements exploit an optical structure whereof one face is exposed to the air, so that the difference between the refractive indices of air and of the material of the structure produces the desired refraction of the light rays.

The optical effects obtained by the use of lens arrays have been described in particular in the article “The History of Integral Print Methods” taken from “Lenz Array Print Techniques” by David E. Roberts and Trebor Smith, the article “The moiré magnifier” by M C Hutley et al., 1994 IOP Publishing Ltd., and the publication “Academy of the Sciences”, of the Session of 2 Mar. 1908.

Miscellaneous optical structures are also known from the publications U.S. Pat. No. 3,241,429, U.S. Pat. No. 3,154,872, U.S. Pat. No. 3,576,089, U.S. Pat. No. 4,645,301, U.S. Pat. No. 4,892,336, U.S. Pat. No. 6,833,960, WO 94/27254, WO 2005/052650, U.S. Pat. No. 6,856,462, US 2005/184 504, U.S. Pat. No. 5,708,871, WO 2005/058610, US 2005/150964, US 2009/008923, WO 2007/020048, and WO 2009/017824.

Lens arrays have been used in the prior art for superimposition on printed patterns in order to generate effects of motion during observation, particularly by magnifying moiré effects.

U.S. Pat. No. 7,497,475 and WO 2007/133613 describe security documents comprising optical structures, on which prints are made directly.

A need exists to benefit from security elements comprising an optical structure capable of producing novel optical effects that can contribute to the authentication and/or identification of an object, particularly in a simplified manner.

The invention therefore relates, in one of its aspects, to a security element which, prior to the incorporation thereof into an object, particularly a security document, comprises a substrate bearing at least:
an optical structure, in particular an optical structure producing at least one image of at least one comparison pattern and/or producing image points of a light source illuminating the optical structure,
a reference pattern,
   the optical structure and the reference pattern being borne by the substrate in order to allow the simultaneous observation of an image provided by the optical structure and of the reference pattern.

One of the images provided by the optical structure may correspond substantially to the reference pattern.

The reference pattern and/or comparison pattern may consist of a plurality of juxtaposed elementary patterns, reference and/or comparison patterns, respectively. It may in particular concern arrays of elementary patterns, for example associated, in the case of a comparison pattern formed by an array of elementary comparison patterns, with an optical structure formed by a plurality of elementary optical structures, particularly such as lenses. In particular, each elementary optical structure may allow the observation of an image of a given elementary comparison pattern.

The expression “corresponding substantially”, means in particular that the simultaneous observation of the optical structure and of the reference pattern serves to grasp a resemblance or a complementarity between the images observed. In particular, at least one of the images provided by the optical structure and the reference pattern may resemble, complement or be superimposed on one another, at least partially, even better completely, corresponding for example to the same alphanumeric character, sign, logo, symbol, person or object. In the case of a complementarity, at least one of the images of the comparison pattern produced by the optical structure may be the symbol of a currency whereas the reference pattern is the quantified amount corresponding to the security document.

The invention may serve for the simplified authentication and/or identification of an object, particularly a security document, comprising a security element as described above, in particular by the observation of the similarities existing between at least one of the images provided by the optical structure and the reference pattern.

Furthermore, the invention may serve to obtain a security element of simplified manufacture, which can easily be incorporated in a security document, by providing a given substrate with a reference pattern and an optical structure, in which case the latter may, if applicable, be superimposed on a comparison pattern borne by the substrate.

The reference pattern may provide a stationary image, in particular regardless of the angle of observation.

The reference pattern and/or the comparison pattern may consist of at least two elementary patterns, reference and/or comparison patterns, respectively.

The reference pattern may be observed independently of the optical structure. It may in particular be located outside the zone comprising said optical structure.

The substrate may bear at least one comparison pattern, the optical structure being superimposed on said comparison pattern.

The optical structure may produce at least one enlarged image of the comparison pattern. The magnification may, for example, be higher than 1.5, better 2, even better 3, for example between 1.5 and 5. The high magnifications will be used in particular in the case in which the pattern, or the elementary patterns, associated with the optical structure, has/have very small dimensions. The high magnifications can be obtained, for example, by magnifying moiré effect, as described in the abovementioned literature.

The optical structure may provide a moving image, in particular an image whose dimensions are variable, an appearing and disappearing image, or more generally a changing image, of one or more comparison patterns, according to the angle of observation. In the case of an effect of movement, the amplitude of the movement is commensurate with the rate of magnification. At least one of the images of the comparison pattern may, for example, correspond substantially to the reference pattern, so that a user can observe both the reference pattern independently of the angle of observation and a moving image for the comparison pattern according to the angle of observation.

The comparison pattern may be arranged, in particular with regard to the optical structure, to allow the observation of at least one image in 2D or in 3D.

The comparison pattern may in particular use the magnifying moiré principle to restore an effect of depth or an impression of movement. It may also comprise at least one image produced by the interlacing of at least two images, for example to restore, during a change of angle of observation, an animation or an effect of movement.

The optical structure and the comparison patterns may be configured in particular positioned with regard to one another in order to create a magnifying moiré effect or an animation effect caused by the observation of at least two different images during a change in the angle of observation. The animation effect may be obtained with a comparison pattern formed by interlacing said at least two different images.

At least two comparison patterns, optionally consisting of a plurality of elementary patterns, may be located at different distances from the optical structure, and in particular from the focus of a lens of the optical structure, so that the images of these comparison patterns through the optical structure each appear in different planes, particularly in planes located at different depths.

For example, it is possible to form, particularly by printing, on a comparison pattern, optionally consisting of a plurality of elementary comparison patterns, or on the face of the substrate opposite the face bearing the comparison pattern, a secondary comparison pattern, particularly of different size. In the case of a secondary comparison pattern formed on the face of the substrate opposite the face bearing the comparison pattern, the secondary comparison pattern may or may not be superimposed on the comparison pattern. Accordingly, at least one of the images of the comparison pattern and at least one of the images of the secondary comparison pattern may be observed in different planes.

An additional pattern may be formed, particularly by printing, on the face of the substrate opposite the face bearing the comparison pattern or on a plurality of comparison patterns or even on a comparison pattern consisting of a plurality of elementary comparison patterns. The dimensions of the additional pattern may be selected so that only the comparison patterns or the elementary comparison patterns are affected by the optical structure, the additional pattern constituting a background on which the image is observed through the optical structure of the comparison patterns or the elementary comparison patterns.

At least one of the images of the comparison pattern may optionally be observable only under a predefined lighting, for example ultraviolet and/or infrared.

The reference and comparison patterns, and/or the images observed of these patterns, may or may not have the same color, or the same orientation.

The reference and comparison patterns may be of different sizes and/or colors, and the images observed of these patterns may have the same size and/or color, or vice versa.

The reference pattern and/or the comparison pattern may have an area of between 10 and 60 mm², for example about 40 mm².

The reference and comparison patterns and/or the images observed of these patterns, may have shapes and/or dimensions, particularly size, which are similar or even identical.

The dimensions of the comparison and reference patterns borne by the substrate of the security element may be identical or approximately identical. Alternatively, the scale between the reference and comparison patterns may be variable. For example, the comparison pattern, respectively the reference pattern, may have a size of between 0.5 and 3 times the size of the reference pattern, or of the comparison pattern, respectively.

When the reference and comparison patterns are made with different sizes, the optical structure may be prepared to modify the apparent size of the comparison pattern so that the apparent size of the comparison pattern as observed via the optical structure is approximately equal to that of the reference pattern. The apparent size of the comparison pattern observed via the optical structure may even have a size of between 0.5 and 3 times the size of the reference pattern.

For example, a 5 mm² reference pattern and a 1.25 mm² comparison pattern with a targeted magnification of 3 serve to obtain the same observed appearance despite a comparison pattern having an area of 0.25 times that of the reference pattern.

Similarly, to obtain a magnification of 150 for the comparison pattern with the same 5 mm² reference pattern, the comparison pattern must have an area of 0.025 mm², or 0.005 times the size of the reference pattern.

The largest dimension of the reference pattern may, for example, be between 1 and 3 mm.

The largest dimension of the comparison pattern is preferably lower than the largest dimension of the reference pattern. The largest dimension of the comparison pattern is, for example, between 0.1 and 0.3 mm.

The largest dimension of at least one of the images observed on the comparison pattern may be substantially equal to the largest dimension of the reference pattern, for example between 1 and 3 mm.

The security element may comprise a plurality of reference patterns and/or comparison patterns borne by the same face of the substrate or not, for example more than 2, better more than 3, even better more than 4.

The security element, particularly the substrate of the security element, may comprise alternating reference patterns and comparison patterns in at least one direction of a plane of the security element, serving for example to observe alternating stationary images and moving images.

The number of reference patterns may or may not be identical to the number of comparison patterns.

The comparison pattern and/or the reference pattern may be formed on the substrate by metallization and/or demetallization, for example with aluminum. Metallizations and/or demetallizations are more difficult, or even impossible to reproduce by printing due to their fineness which may serve to prevent counterfeiting by printing.

The comparison pattern and/or the reference pattern may be formed in positive or negative on the substrate of the security element. In particular, all the comparison patterns and all the reference patterns may be formed in positive, or alternatively all in negative.

The comparison pattern and/or the reference pattern may be formed by printing. The reference pattern and/or the comparison pattern may be borne on the substrate of the security element, for example by a printing process such as offset, steel engraving, laser, inkjet, microlithography, photogravure or screen printing.

The reference pattern and/or the comparison pattern may be printed with colored or uncolored inks which are visible to the naked eye, under ultraviolet (UV) and/or infrared (IR) light, and are opaque, fluorescent, phosphorescent, thermochromic, photochromic, translucent and/or transparent, inter alia.

The reference patterns may in particular be formed in positive by metallization of the substrate or in negative by demetallization of the substrate, and the comparison patterns may for example be prints made on the substrate.

The reference and/or comparison patterns may be formed by offset, laser, inkjet printing or steel engraving by flexography, by lithography (and microlithography), by photogravure and by screen printing. The patterns comprise for example micropatterns made by microlithography or by steel engraving.

The optical structure may focus the light in image points, the image provided by the optical structure resulting from the focusing at the image points of at least one light source illuminating the optical structure. In this case, the substrate may bear only the reference pattern, and the optical structure may in particular be devoid of a comparison pattern.

The optical structure, for example consisting of a plurality of elementary optical structures, may have different sizes or shapes, in order to produce image points at various distances, for example.

The light source illuminating the optical structure for the purpose of producing the image points is, for example, the sun or an electric lamp, particularly a source whereof the incident rays are parallel or substantially parallel.

The images provided by the optical structure and the reference pattern may be observable in reflection and/or transmission. In the case in which at least one of the images provided by the optical structure results from the observation of image points of a light source, said image may be observed in reflection.

The substrate may or may not bear the optical structure and the reference pattern on the same face.

The substrate may or may not bear a comparison pattern on the face opposite the face bearing the optical structure.

Preferably, the substrate bears the reference pattern and the comparison pattern on one of its faces, and the optical structure on the opposite face.

The substrate may be at least partially transparent or translucent. The substrate may for example be or comprise a film of thermoplastic material that is transparent or not, for example polyester or PET.

The security element may or may not extend from one edge to the other of an object incorporating same, particularly a security document.

The security element may be a security thread, a security film or a patch.

Preferably, the security element is a security thread. The security element may have a width for example greater than or equal to 4 mm, better 5 mm, even better 6 mm, for example of between 6 and 8 mm, better between 6 and 10 mm.

The security element in the form of a security film or a patch may for example be incorporated in a security sheet comprising a zone of reduced thickness intended to accommodate the security element.

Advantageously, the width of the security element in the form of a security thread may allow the security element to comprise a reference pattern, an optical structure and optionally a comparison pattern having sufficient dimensions to allow its easy observation by the naked eye, while also serving to incorporate at least one other type of security element on the security thread, as described below, in particular metallizations and/or demetallization which may or may not be associated with magnetic elements.

In the case in which the reference pattern is printed, conductive transparent inks may be used on the zone of the reference pattern and/or the reference patterns can be printed with a magnetic and/or conductive ink, for example black in colour, for example based on carbon black.

In the case of a security element in the form of a security thread, the optical structure may only extend partially over the width of the security thread, so that the substrate of the security thread has at least one border zone not covered by the optical substrate. Such a security thread may, for example, be introduced in a window of an object.

The border zone may or may not be metallized. The border zone may not be covered by a comparison pattern and/or a reference pattern and/or an optical structure. The border zone may be continuous or discontinuous.

The border zone may extend from one edge to the other of the security element, in particular along the length of the security element.

The border zone, particularly where it is devoid of an optical structure, may be covered, at least partially, with an adhesive, particularly a heat seal varnish. A border zone covered with such an adhesive may serve to reinforce the cohesion between the security element and an object in which it is incorporated. The security element is, for example, incorporated in a window made in a fibrous base of the object with at least partial overlapping between the edges of the window and the adhesive of the border zone. Due to this overlap, the fibers of the base of the object may be joined to the security element. The cohesion between the security element and the object may be thereby reinforced, particularly when the security element is placed in a window, which may make it more difficult to extract the security element from the object without damaging the security element. This can also reduce the risk of a security element placed in a window of a base of an object being removed from said object and then reintroduced into another object.

The border zone may be covered with adhesive over its entire length along the security thread, as opposed to what is described in application US 2008/0182084.

The border zone may or may not comprise at least one magnetic or conductive element, particularly in the form of a patch. In this way, it is possible to impart electrical properties and/or magnetic properties to the security element.

The width of the border zone may, for example, be between 0.5 and 2 mm, for example 1.5 mm.

The width of the space between two border zones, or between a border zone and an edge of the security element, is for example between 2 and 9 mm, for example between 3 and 6 mm.

The security element may advantageously comprise at least two border zones close to each of its edges, particularly of its edges along its length.

The security element may or may not be incorporated in window(s) in an object, particularly a security document. When the security element is incorporated in window(s) in a security document, the window may advantageously allow the simultaneous observation within the window of at least part of the image provided by the optical structure and of the reference pattern.

The security element may also be incorporated completely or partially in an object, particularly in the paper mass of a security document. The security element incorporated in an object may be completely or partially visible along a single one of its faces or along both of its faces.

The observation of the security element may or may not be carried out via a mask comprising an opening, the mask being placed on the security element so that the opening makes it possible to simultaneously observe at least part of a reference pattern and at least part of the optical structure, for example close to one another, particularly juxtaposed with one another.

### Optical Structure

The optical structure may have a nonplanar surface turned toward the observer.

The optical structure may extend only partially on the substrate. The optical structure may or may not extend from one edge of the substrate to the other, for example along its width and/or its length.

The substrate may have one or more zones devoid of the optical structure and one or more zones covered by the optical structure.

The optical structure may be discontinuous. In particular, the optical structure may consist of a set of disjointed optical substructures, identical or not. These optical substructures may comprise elementary optical structures, for example lens arrays, said elementary optical structures being disjointed or not and identical or not.

The optical structure may be reflective or not. Alternatively, it may be partially reflective, for example semi-reflective.

The optical structure may have an elongate form along a longitudinal axis.

The optical structure may have any geometric shape, for example a polygonal contour or not, for example square, rectangle, diamond, triangle, trapezoid, parallelogram, circular, elliptical, inter alia.

The elementary optical structures constituting the optical structure may or may not all have the same geometric shape. The elementary optical structures may for example all have the shape of a pyramid or a truncated pyramid, a sphere or a frustoconical sphere, cylinders, Fresnel lenses. The elementary optical structures, identical or not, may be arranged on the security element at regular or irregular intervals.

The optical structure may not be superimposed on the reference pattern. In particular, the optical structure may only be superimposed on the comparison pattern. The absence of an optical structure superimposed on the reference pattern may serve to cover the latter for example with an adhesive, particularly a heat seal varnish, without affecting the observation properties of the optical structure. The application of the adhesive to the optical structure which could affect the visibility of the comparison pattern or patterns because of the refractive indices present, may thereby not be necessary for incorporating the security element in the security document.

The optical structure may comprise a lens array having a thickness for example between 2 and 25 μm, for example equal to 6 μm, and a lens diameter for example between 5 and 60 μm, for example equal to 20 μm.

The optical structure may have a surface, reflective or not, having an at least partially spherical, optionally frustoconical, polyhedral, in particular pyramidal shape, with an optionally frustoconical apex, inter alia. The optical structure may further comprise a Fresnel lens.

Depending on the shape of the surface of the optical structure and the positioning of the comparison pattern with regard to said surface, it may be possible for example to obtain at least one enlarged or reduced image of the comparison pattern. The security element may thus be configured to produce at least one enlarged image of the comparison pattern, erect or reversed, in the application of the laws of geometric optics. It is in particular advantageous to obtain an enlarged image of the comparison pattern thanks to the optical structure because this can facilitate the observation of a small comparison pattern with the naked eye. In particular, the dimensions of the comparison pattern, particularly the largest dimension, may be reduced with regard to the dimensions, in particular the largest dimension, of the reference pattern.

The optical structure may be produced by embossing, particularly by heat embossing or by embossing followed by crosslinking with ultraviolet, or by molding. The optical structure may further comprise a printed lens array comprising juxtaposed lenses or not, for example by UV printing, for example by screen printing, photogravure, typography, or even by inkjet printing.

The optical structure may be produced by screen printing, photogravure, flexography or offset printing.

The preparation of an optical structure by printing or embossing may advantageously serve to prepare the comparison pattern or patterns in a registered manner with regard to the corresponding reference pattern(s).

The optical structure may comprise a concave, convex or Fresnel lens, a lens array.

The optical structure may also comprise a resin or varnish print, for example crosslinkable by ultraviolet radiation.

In the case of a reflecting optical structure, the optical structure may consist of elementary optical structures in the form of mirrors placed in a uniform array, along one or more directions.

In the case of a reflecting optical structure, the reflecting surface of the optical structure may be produced by the metallization of a nonplanar surface, thereby benefiting from a continuous reflecting surface, whereas the embossing of a film on a transparent substrate covered on one face with a metal film would be liable to break the metal surface and thereby lead to the formation of unattractive cracks and/or liable to make the optical structure partially inoperative.

The abovementioned mirrors may in particular be formed by the metallization of a lens array, one nonplanar face of the array being preferably metallized after the manufacture of said array, to avoid breaking the metal film, as explained above. The mirror or mirrors may be of various types, for example “inclined”, concave, convex, cylindrical, parabolic, pyramidal, spherical or aspherical planes. Within the array, all the mirrors may be identical or not.

The at least partially reflective optical structures may also be obtained by producing a Fresnel lens accommodating a metallization.

In the exemplary embodiments of the invention, the at least partially reflective optical structure or structures are concave toward the associated comparison pattern or patterns in order to produce at least one enlarged image of the associated comparison pattern or patterns, and serve to observe the comparison pattern or patterns more easily, despite their small size.

The optical structure, for example the abovementioned lens array, may be formed on the substrate, from the same material or not, being added thereon or not. The optical structure may be prepared for example by printing or embossing.

The thickness of the substrate is for example between 5 and 100 μm, preferably 20 and 30 μm. The substrate may have a constant thickness. The thickness of the substrate may optionally be selected according to the optical structure, for example according to the focal distance of the mirror, so as to have the desired optical effect.

The abovementioned optical structure may be prepared in such a way that the associated comparison pattern is located between the substrate and the optical structure. In this case, the thickness of the substrate may not substantially modify the visual effect obtained.

The optical structure may cover one face of the substrate and the comparison pattern or patterns may be formed thereon on the opposite face. In this case, the choice of the thickness of the substrate serves to place the comparison pattern closer to or further from the optical structure, and may serve to adjust the distance from the comparison pattern to the optical structure according to the focal length thereof.

The lens array may comprise an array of spherical lenses, for example concave toward the substrate. In exemplary embodiments of the invention, the apex angle of a mirror, particularly when the latter is concave toward the associated comparison pattern, may be between 30 and 45 μm. The distance between the mirror apex and the adjacent face of the substrate is for example between 10 and 20 μm, ranging for example between 14 and 16 μm. The comparison pattern associated with the mirror may be completely located in the concavity of the mirror. The diameter of the mirror, at its face adjacent to the substrate, is for example between 50 and 70 μm, ranging for example between 58 and 62 μm.

The abovementioned optical structure may be metallized by a vacuum metallizing technique, the metal used being aluminum for example.

The security element may comprise optical structures of different types.

The optical structure may comprise nonplanar elementary reflective surfaces, for example concave or convex, whereof a small dimension, particularly the height, is for example greater than or equal to 20 μm, for example 30 μm.

The optical structure may be covered, preferably partially, with at least one optical structure inactivation varnish, nullifying the optical effect or effects obtained by the optical structure. Said inactivation varnish has for example a refractive index equal to or sufficiently close to that of the optical structure for the optical structure to stop producing its effects. The inactivation varnish may be transparent, colored or not.

The presence of an inactivation varnish on the optical structure may thus serve to create one or more zones without optical effect on the optical structure, serving if applicable to make a pattern underlying the optical structure visible without a magnifying effect by the optical structure.

The inactivation varnish may be superimposed on a reference pattern borne by the substrate, for example borne by the face of the substrate opposite the face bearing the optical structure. In this way, the presence of the inactivation varnish, by nullifying the optical effect or effects of the optical structure, may make it possible to observe the reference pattern through the optical structure without this observation being affected by the optical structure. The observation of the reference pattern through the optical structure covered with such an inactivation varnish may in particular correspond to the observation of the reference pattern that would be made directly without the presence of the optical structure.

The inactivation varnish may, for example, have a refractive index higher than that of air. The refractive index of the inactivation varnish may for example be the same as the refractive index of the optical structure, particularly of the zone of the optical structure to which the inactivation varnish is applied. The refractive index of the inactivation varnish may generally be selected so that it serves to nullify the optical effect or effects obtained by the optical structure.

The inactivation varnish may for example be applied to the optical structure by a printing method.

The outer surface of the inactivation varnish may be suitable for nullifying the optical effect or effects obtained by the optical structure. It is preferably planar.

The inactivation varnish and heat seal varnish may form one and the same varnish.

Alternatively, the security element comprises heat seal varnish and inactivation varnish present in distinct form. The inactivation varnish may then be placed between the security element and the heat seal varnish.

The optical structure may completely cover the face of the substrate that bears it and comprise an inactivation varnish nullifying in places the optical effect or effects of said optical structure. In this way, the method for manufacturing the security element can be simplified. For example, using a substrate bearing on at least one of its faces an optical structure completely covering said face, the manufacturing method may comprise the step consisting in forming one or more reference patterns and/or comparison patterns, particularly by printing, on the substrate, and in applying an optical structure inactivation varnish to the substrate, particularly on a face of the substrate opposite the face bearing the reference and/or comparison pattern or patterns, the reference and/or comparison patterns and the inactivation varnish being applied in a registered manner.

The use of an inactivation varnish as described above may particularly be applicable when the optical structure has one or more optical effects deriving from the non-planeity between the ambient air and the optical structure, particularly when the optical structure comprises a lens array.

The optical structure inactivation varnish may be partially or completely covered with an adhesive as described above, particularly a heat seal varnish.

The adhesive as mentioned above may, if applicable, be an inactivation varnish, nullifying the optical effect or effects obtained by the optical structure.

### Adhesive

Advantageously, the security element comprises at least one adhesive, particularly a heat seal varnish (or resin). The adhesive may for example serve to improve the adhesion of the security element to a security document.

The adhesive may for example be borne by each face of the substrate, or alternatively, by a single face, bearing the optical structure or not.

The face of the substrate bearing the optical structure may comprise an adhesive on zones of said face not covered by the optical structure, the optical structure being in particular devoid of adhesive on its surface.

Advantageously, the presence of the adhesive only in zones of the substrate that are not covered by the optical structure may serve to avoid affecting the observation properties of the optical structure.

The adhesive may or may not be in contact with the reference pattern and/or the comparison pattern.

The adhesive may cover the reference pattern, being in contact therewith or not, without covering the optical structure, so as to improve the behavior of the security element in or on an object, particularly a security document.

The adhesive may be transparent, translucent or opaque. The adhesive may be heat sealable. The adhesive may be colorless or colored, visible to the naked eye, under ultraviolet light (UV) and/or infrared light (IR), fluorescent, phosphorescent, thermochromic, photochromic, inter alia.

The adhesive placed on one face may be colored, and associated with a substrate or with a second adhesive placed on the other face having another color. In particular, when the adhesive on the one hand, and the substrate or the second adhesive on the other hand, have different fluorescent colors, a similar effect is obtained to the one described in application FR 2 877 609.

The adhesive may form a corresponding pattern, for example identical, or complementary to the comparison pattern and/or to the reference pattern. The adhesive may in particular be visible under UV and/or IR illumination, fluorescent or phosphorescent.

The adhesive may completely cover one face of the substrate bearing the reference pattern and the comparison pattern, being in particular in contact therewith, the optical structure being borne by the opposite face of the substrate.

The adhesive may for example be a heat seal coating, for example a heat seal varnish, a crosslinkable agent under ultraviolet (UV), an adhesive to be irradiated, a pressure sensitive adhesive (PSA), a varnish with a solvent base, of the polyester type for example, an aqueous adhesive, etc.

As an aqueous adhesive, mention can be made in particular of the following trade marks: Mowilith DC (aqueous dispersion of vinyl acetate homopolymer with particles ranging from 0.3 μm to 2 μm in size and having a glass transition temperature T_{g} of about 38° C., and a dry solids content of 55 to 57%) and Vinamul 3265 from CELANESE; DH9004, DH9017, DH9044 and DL5001 from COLLANO; Primal NW1845, Primal LC40, Primal P308M and Primal EP6000 from ROHM & HAAS; 006SDW078-2 from BASF.

The adhesive may advantageously be an adhesive based on polyvinyl acetate such as Mowilith DC.

The incorporation of the adhesive in the security element may be carried out by coating or by printing.

The coating may be carried out before or after the formation of the reference pattern and the optical structure, and optionally the comparison pattern, on the substrate.

The coating may be carried out on a single face of the substrate or on both faces of the substrate. The adhesive may completely cover the face on which it is deposited.

### Object

The invention further relates to an object, particularly a security document, incorporating a security element as defined above. Such a security document may comprise a paper fiber base and the security element may have at least one visually accessible portion, for example extending in window(s) in said fibrous base.

The security element may be intended to be observed from a single face of the document, the mirror or mirrors or other optical elementary structures being formed on the side of the substrate opposite the face turned toward the observer. Alternatively, the security element may, on a portion of its length, comprise mirrors turned toward one of the faces of the substrate, and on another portion of its length, mirrors turned toward the opposite face of the substrate, so as to allow the observation of one or more comparison patterns by reflection of their image on the reflective surface of the corresponding mirror or mirrors, independently of the observation face of the security element. Other combinations of optical structures are feasible, particularly the combination of concave and convex spherical mirrors.

The metallization thickness defining the reflective surface of the mirror may be sufficient to make the mirror opaque. Alternatively, the thickness is sufficiently thin to impart a semi-reflective character to the mirror. If applicable, the metal film may comprise partial demetallizations, for example obtained by carrying out the metallization through a mask.

The reflective effect may further be obtained by the application of a high-refractive-index layer. In this case, the reflective structure may not necessarily comprise a metallization. High-refractive-index layers are formed of high-refractive-index (HRI) compounds, for example such as zinc sulfide. These compounds are used in particular to produce holograms.

The invention further relates, in another of its aspects, to an object, particularly a security document, comprising a paper fiber base and at least one security thread incorporated in the fibrous base, the security thread comprising, prior to said incorporation in the object, a substrate bearing at least:
an optical structure, particularly an optical structure producing at least one image of at least one comparison pattern and/or producing image points of a light source illuminating the optical structure,
a reference pattern,
   the optical structure and the reference pattern being borne by the substrate to allow the simultaneous observation of a given image by the optical structure and of the reference pattern,
   the security thread, when incorporated in the object, having at least one visually accessible portion extending in window(s) in said fibrous base and border zones of the substrate being devoid of optical structure and covered with an adhesive.

### Other Security Elements

The security document, or the security element comprising same, may comprise one or more additional security elements as defined below.

Among the additional security elements, some are detectable to the naked eye, in daylight or in artificial light, without using a particular apparatus. These security elements comprise for example colored fibers or planchettes, totally or partially printed or metallized threads. These security elements are called first level elements.

Other types of additional security elements are detectable only using a relatively simple apparatus, such as a lamp emitting in the ultraviolet (UV) or infrared (IR). These security elements comprise for example fibers, planchettes, strips, threads or particles. These security elements may or may not be visible to the naked eye, being for example luminescent under the illumination of a Wood's lamp emitting in a wavelength of 365 nm. These security elements are called second level elements.

Other types of additional security elements further require a more sophisticated detection apparatus for their detection. These security elements are for example capable of generating a specific signal when they are subjected, simultaneously or not, to one or more external excitation sources. The automatic detection of the signals serves to authenticate the document, if applicable. These security elements comprise for example tracers having the form of active materials, particles or fibers, capable of generating a specific signal when said tracers are subjected to an optronic, electrical, magnetic or electromagnetic excitation. These security elements are called third level elements.

The additional security element or elements present in the security document, or the security element that it comprises, may have first, second or third level security features.

The additional security element or elements may for example appear on one or more border zones of the security element. For example, the security element may, in a central zone of the substrate, comprise a reference pattern, an optical structure and optionally a comparison pattern, and in one or more border zones, one or more additional security elements.

### Manufacturing Method

The invention further relates, in another of its aspects, to a method for manufacturing a security element comprising a substrate, in which:
at least one reference pattern and optionally at least one comparison pattern is made on the substrate,
at least one basic optical structure, for example an array of elementary optical structures, superimposed, if necessary, on at least one comparison pattern, is made on the same substrate.

The optical structure may be formed for example by flexography, inkjet, offset or screen printing, for example, of a point of ink of a transparent polymer crosslinkable under UV, or by heat embossing of a thermoplastic support with a metal die etched in the form of a lens, among other alternatives.

The optical structure may or may not be formed on the same side of a substrate as the comparison pattern, with or without register of the basic optical structure with regard to the comparison pattern. In case of register, the comparison pattern is for example centered on the optical axis of the basic optical structure.

A lens array can be prepared comprising a plurality of identical lenses, which are metallized in order to form an array of nonplanar mirrors.

### Authentication or Identification Method

The invention further relates to a method for authenticating or identifying an object as defined above, in which the reference pattern and the image provided by the optical structure are observed simultaneously, and information concerning the identity or authenticity of the object is determined at least from said observation.

### DESCRIPTION OF THE FIGURES

The invention can be better understood from a reading of the detailed description that follows, of nonlimiting exemplary embodiments thereof, and the examination of the appended drawing, in which:

FIG. 1 shows a schematic and partial cross section of an exemplary embodiment of a security element of the invention, comprising a nonreflective optical structure,

FIGS. 2 and 3 show a front view of the observation of security elements like the one in FIG. 1,

FIG. 4 shows a schematic and partial cross section of another exemplary embodiment of a security element of the invention, comprising a reflective optical structure,

FIGS. 4A to 4C show steps in the production of the reflective optical structure of FIG. 4,

FIGS. 5 to 7 show examples of objects comprising a security element of the invention,

FIGS. 8 and 9 show alternative embodiments of reflective optical structures,

FIG. 10 is a view similar to that in FIG. 9 of an alternative embodiment,

FIG. 11 is a plan view along X of FIG. 10,

FIG. 12 shows a mesh along which some reflective structures can be arranged,

FIG. 13 shows an example of a reflective structure,

FIG. 14 shows an example of a pattern which can be prepared with the reflective structures of FIG. 13,

FIG. 15 shows another example of a reflective structure,

FIG. 16 shows the reflective structure of FIG. 15, along XV,

FIG. 17 shows another example of a security element of the invention,

FIG. 18 is a view along XVII-XVII of FIG. 17,

FIGS. 19 and 20 show respectively, in a front view, the front and back of another example of a security element of the invention,

FIGS. 21 and 22 show, respectively in cross section and front view, another exemplary embodiment of a security element of the invention,

FIGS. 23 to 25 show, in cross section, other exemplary embodiments of security elements of the invention,

FIGS. 26 and 27 show other exemplary embodiments of security elements of the invention, and

FIGS. 28 to 33 show objects incorporating a security element according to examples of implementation of the invention.

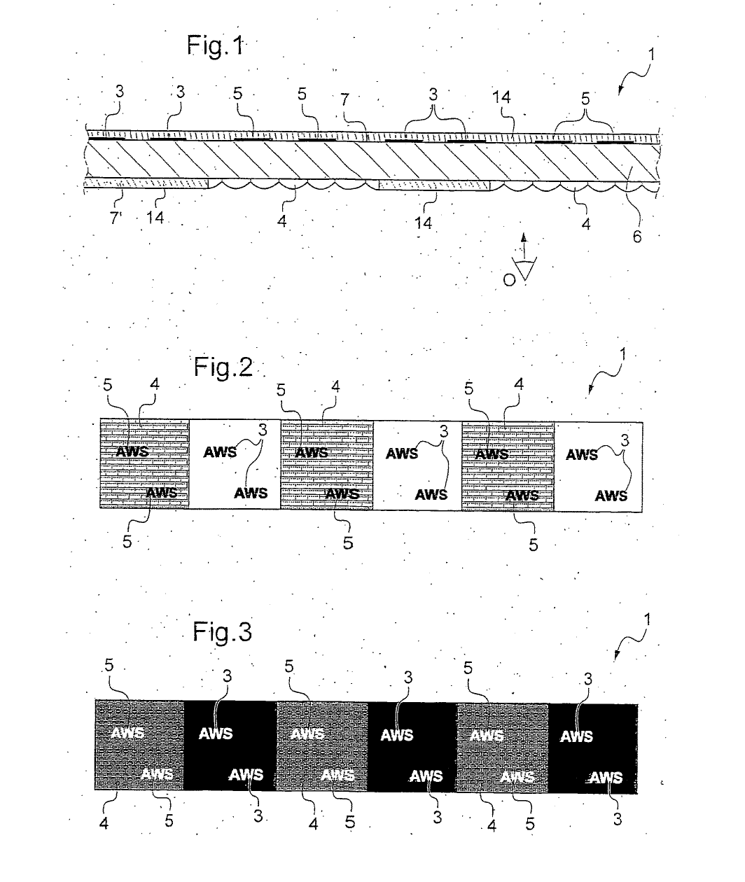

The security element 1 shown in FIG. 1 comprises a substrate 6 whereof a front face 7 is covered with a plurality of reference patterns 3 and a plurality of comparison patterns 5, formed for example by microprinting, particularly by a microlithography or steel engraving technique. The comparison patterns 5 and the reference patterns 3 may for example be printed with a white or colored ink. The comparison patterns 5 and the reference patterns 3 may be such as described above, particularly having the same size or not, having the same color or not, or even the same orientation or not.

The substrate 6 is for example a transparent film of a synthetic material, for example a thermoplastic, particularly polyester.

The substrate 6 bears on its back face 7′, a nonreflective optical structure 4, consisting of a plurality of optical substructures. In the example in FIG. 1, these optical substructures are disjointed and are formed by elementary optical structures such as lenses. These elementary optical structures may be disjointed or not and/or identical or not.

The reference patterns 3 correspond substantially to the images of the comparison patterns 5 for the optical structure 4. In this way, the authentication and/or identification of the security element 1 can be made by the observation of the back face 7′ of the substrate 6 bearing the optical structure 4.

FIGS. 2 and 3 show, in a front view, examples of observation of a security element 1 of the invention, obtained for example from the security element 1 of FIG. 1.

FIG. 2 shows the observation of a security element 1 in which the comparison patterns 5 and the reference patterns 3 have been made in positive, for example by metallization.

FIG. 3 shows an example of observation of a security element 1 from the invention, in which the comparison patterns 5 and the reference patterns 3 have been made in negative, for example by demetallization.

The observation of the images obtained from the comparison patterns 5 and the reference patterns 3 can serve to authenticate and/or to identify the security element 1 thanks to the visual similarity observed.

The security element 1 may be covered on one or both of its outer faces with an adhesive 14, particularly a heat seal varnish. As shown in FIG. 1, the adhesive 14 may for example completely cover the front face 7 of the substrate 6 bearing the reference patterns 3 and the comparison patterns 5, and only cover the back face 7′ of the substrate 6 between the optical substructures of the optical structure 4, never covering the optical substructures so as to avoid damaging their optical properties.

The adhesive may be transparent at least on the observation side for example. In particular, the adhesive may be a heat activated adhesive, particularly such as a heat seal coating or a heat seal varnish. Such adhesives are particularly advantageous when employed in methods operating at high temperatures, particularly with drying operations routinely used in the papermaking field. As examples of adhesives, particularly of heat seal varnish, mention can be made of a crosslinkable agent under ultraviolet (UV), an adhesive to be irradiated, a pressure sensitive adhesive (PSA), a varnish with a solvent base, of the polyester type for example, an aqueous adhesive, etc. As aqueous adhesive, mention can be made in particular of those known by the following trade marks: Mowilith DC (aqueous dispersion of vinyl acetate homopolymer with particles ranging from 0.3 μm to 2 μm in size and having a glass transition temperature T_{g} of about 38° C., and a dry solids content of 55 to 57%) and Vinamul 3265 from CELANESE; DH9004, DH9017, DH9044 and DL5001 from COLLANO; Primal NW1845, Primal LC40, Primal P308M and Primal EP6000 from ROHM & HAAS; 006SDW078-2 from BASF.

The adhesive 14 may serve to improve the adhesion of the security element 1 in the object in which it is intended to be inserted, particularly a paper mass.

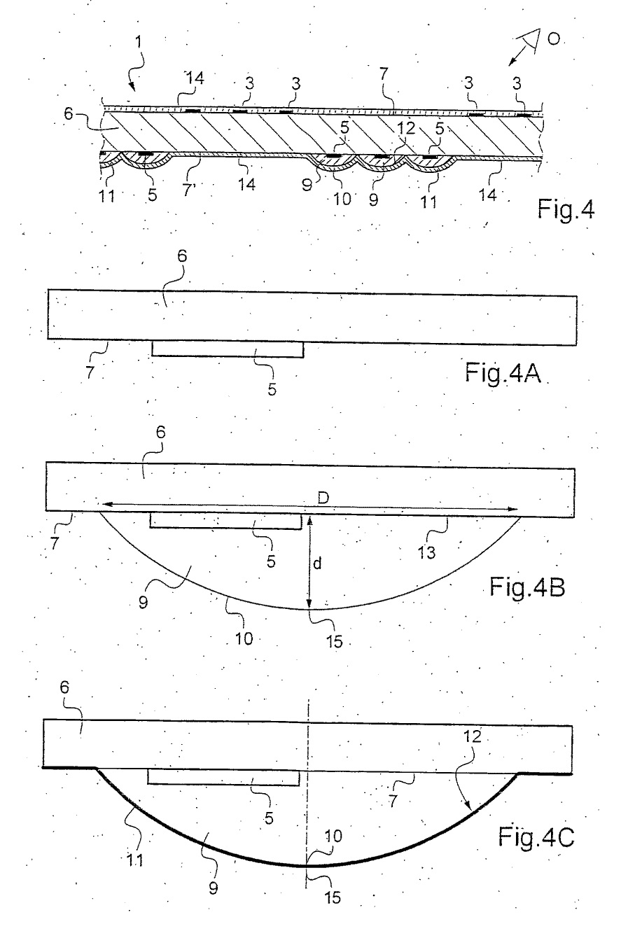

FIG. 4 shows another example of a security element 1 of the invention comprising a reflective optical structure 4.

The security element 1 comprises a substrate 6 bearing for example on its front face 7 reference patterns 3, and on its back face 7′ comparison patterns 5, the optical structure 4 consisting of a plurality of optical substructures superimposed on the comparison patterns 5.

At least one optical substructure, and particularly the reflective optical structure 4 may for example be in the form of an array of elementary optical structures which, in the example considered, are lenses 9. A single lens 9 is shown in FIGS. 4B and 4C and these lenses 9 have a face 10, on the side opposite the substrate 6, which is nonplanar, for example substantially dome-shaped, as shown.

This face 10 may be covered with a reflective coating 11, in order to form a nonplanar mirror 12, constituting a reflective optical structure 4.

FIGS. 4A to 4C show an exemplary embodiment of a reflective optical structure 4 of a security element 1 according to FIG. 4, for example.

The substrate 6 can first be covered with the comparison pattern 5. Then, the lens array can be formed by covering the comparison pattern 5, as shown in FIG. 4B. The lens array can be formed in a registered manner or not with regard to the comparison pattern 5.

The lenses 9 may for example be formed by a printing technique, for example flexography, inkjet, offset or screen printing, of points of ink of a transparent polymer ink which may be crosslinkable under W. The lenses 9 may be produced by photogravure.

The lenses 9 may also be formed by heat embossing of the substrate 6 with a metal die etched in the form of a lens array.

Then, the nonplanar surface of the lens array is metallized, in order to form the mirrors, as shown in FIG. 4C. The metal 11 is for example aluminum.

FIGS. 4B and 4C show that a comparison pattern 5 may be located in the concavity of the corresponding mirror.

In the example considered, the mirror 12 has a concave reflective face and the distance d between the face 7 of the substrate 6 and the bottom 15 (also called “apex”) of the concavity of the mirror 12 is for example 15 μm, for a diameter D of about 60 μm at the interface 13 with the substrate 6.

Thus, the radius of curvature of the mirror 12 may be about 37.5 μm and the focal length of the mirror is then 18.8 μm. In this way, the mirror 12 provides an enlarged image of the comparison pattern 5 to the observer O.

The comparison pattern 5 is for example a 20 μm wide print. The substrate 6 has a thickness of 23 μm for example.

In the example in FIG. 4, an erect virtual image can be obtained that is larger than the comparison pattern 5, the latter being located between the focus and the apex 15 of the concave mirror.

In another alternative embodiment, the mirrors 12 are made with a convex reflective surface toward the comparison patterns, as shown in FIG. 8, thereby producing a smaller image of the comparison patterns.

If applicable, another optical device, for example a magnifying lens, for example a Fresnel lens, may be associated with a reflective mirror in order to again enlarge the image produced by the mirror.

In another alternative embodiment shown in FIG. 9, the image or images seen by the observer do not originate from a printed comparison pattern 5 but consists of the set of luminous points created at the focal distance of each mirror. The mirrors 12 may, as shown, be of different sizes to create luminous image points for example of different sizes or located at various distances from the eye of the observer.

In this case, the comparison is made between the reference patterns 3 and the images formed by the set of luminous points created by the mirrors.

FIGS. 10 to 16 show alternative embodiments in which at least one of the images seen by the observer is due to the way in which the light is reflected by a plurality of reflective structures, of at least two different types.

FIG. 10 shows that the transparent substrate 6 may comprise, on one face, a plurality of reflective structures 4a and 4b, having different respective shapes or dimensions, covered by a layer 11, serving to create a reflective surface, for example a metal film. The reflective structures 4a are for example portions of a sphere as shown in FIGS. 15 and 16, having a height h between 10 and 20 μm for example, about 15 μm for example, and having a diameter Δ of between 20 and 40 μm for example, about 30 μm for example.

The reflective structures 4b are for example mirrors having a pyramidal or truncated pyramid shape, for example having a square base with a side Wₓ or W_{y} for example of between 20 and 40 μm, for example about 30 μm, the larger dimension Wₓ or W_{y} being for example equal to the diameter Δ at the reflective base of the reflective structures 4a.

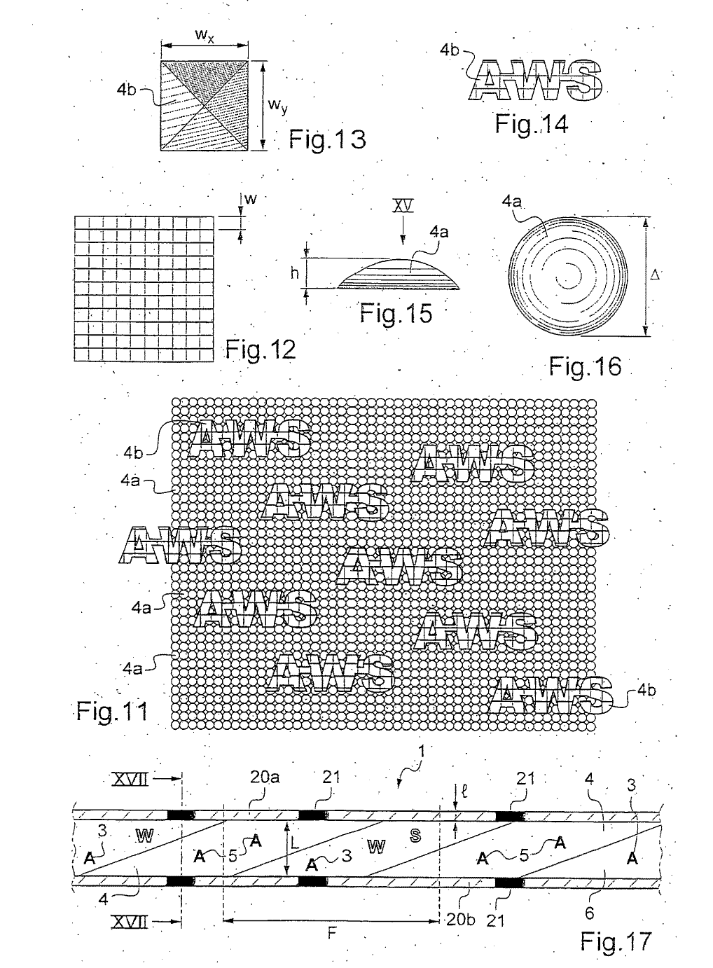

The reflective structures 4b are for example placed like the meshes of an array, shown in FIG. 12, having a pitch W for example equal to Δ, for example about 30 μm. The reflective structures 4b may be arranged according to patterns, as shown in FIGS. 14 and 11. The reflective structures 4a and 4b may be formed in various ways, for example by relief printing followed by metallization of said reliefs.

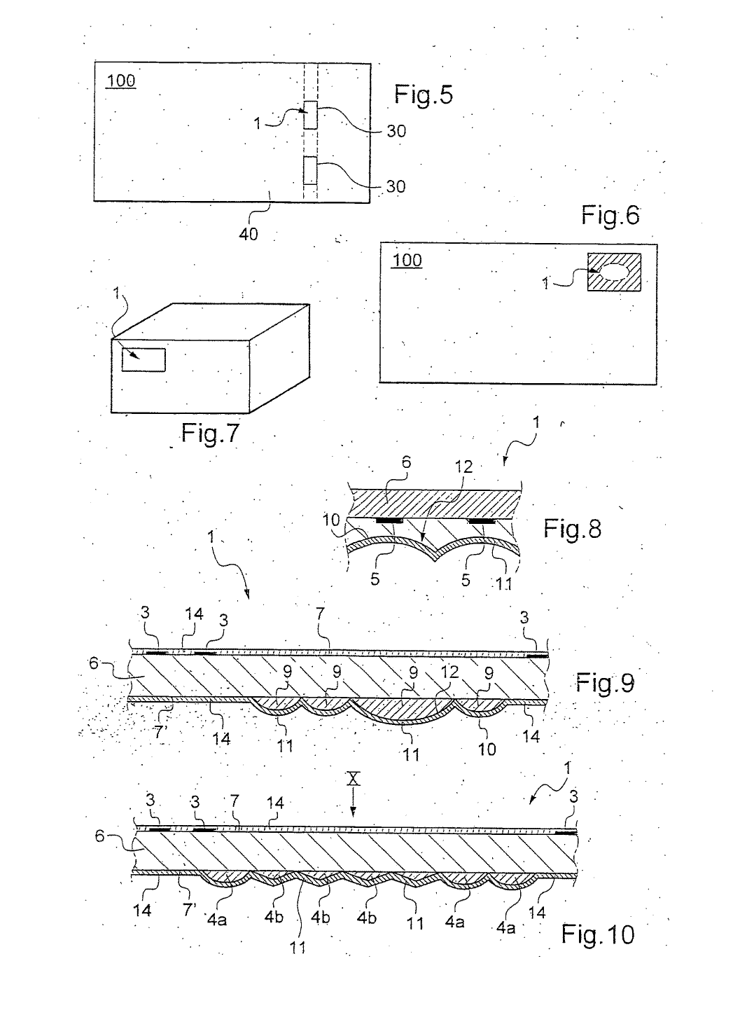

The security element 1 may be in the form of a security thread, for example intended for incorporation in windows in a paper 40, as shown in FIG. 5.

In this case, the security element 1 extends for example between two opposite edges of the paper. The security element may reach the surface of the paper via its outer face located on the side opposite the optical structure, at a window 30.

Alternatively, as shown in FIG. 6, the security element 1 is applied in the form of a patch.

The security element 1 may further be incorporated in a package, as shown in FIG. 7, or in a label.

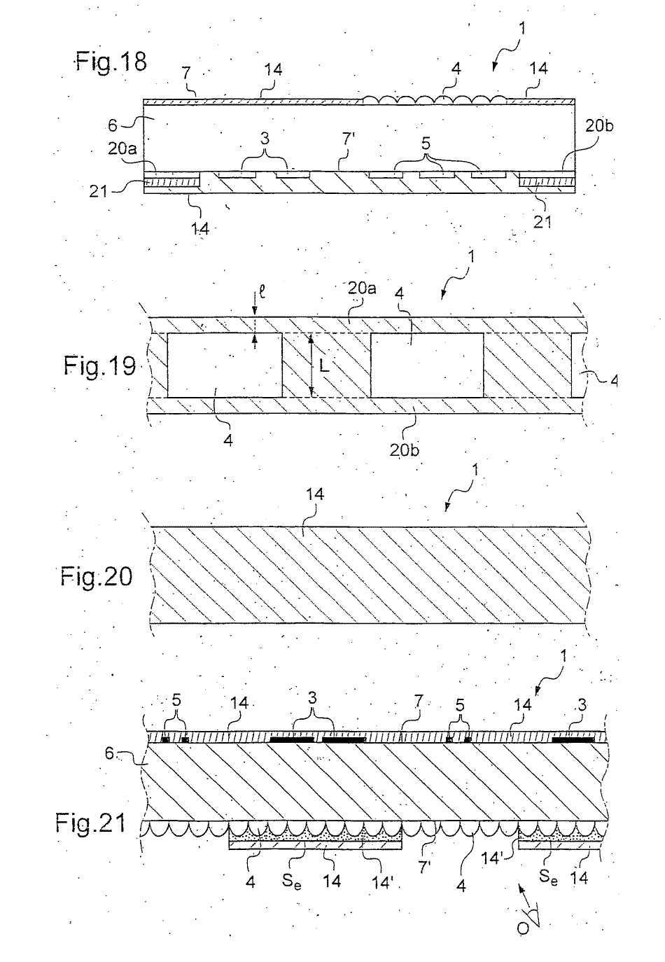

FIGS. 17 and 18 show another example of security element 1 of the invention, in the form of a security thread.

The security element 1 comprises a substrate 6 on the back 7′ of which appear reference patterns 3, produced for example in positive by demetallization.

The security element 1 also comprises comparison patterns 5, formed for example by printing on the substrate 6, having an appropriate size because they are viewed through the optical structure, and positioned alternately in the longitudinal direction with the reference patterns 3.

The security element 1 further comprises an optical structure 4 consisting of a plurality of optical substructures each comprising elementary optical structures and covering the comparison patterns 5.

The optical substructures are for example in the form of parallelograms of which the major side is nonperpendicular to the length of the security element 1, as shown in FIG. 17.

The security element 1 may or may not be incorporated in window(s) in a security document.

During the incorporation in window(s), the window F may for example be prepared so as to be able to observe at least part of a comparison pattern and part of a reference pattern, as shown in FIG. 17.

The security element 1 further comprises at its edges two metallized border zones 20a and 20b, continuous, and comprising magnetic elements 21. In this way, the security element may have electrical conductivity properties and magnetic properties.

The width 1 of the metallized border zones 20a and 20b is for example between 1 and 2 mm, for example equal to 1.5 mm.

The width L of the central zone of the security element bearing the reference patterns 3, the comparison patterns 5 and the optical structure 4, is for example between 3 and 4 mm.

The security element 1 may comprise a substrate 6 made of PET, having a thickness of 23 mm for example.

The optical structure 4 may comprise an array of elementary optical structures which are, for example, lenses having a thickness of 6 μm and a diameter of 20 μm.

The security element 1 may further be covered with an adhesive 14, particularly a heat seal varnish, for example on the entirety of the back face 7′ of the substrate 6 opposite the optical structure 4, as shown in FIG. 18, and exclusively outside the optical structure 4 on the front face 7 of the substrate 6.

The thickness of the adhesive is for example between 3 and 4 μm. The magnetic elements 21 may be printed on the metallized zones 20a and 20b, or alternatively, on the surface of the substrate 6 and then covered by the metallized zones 20a and 20b.

FIGS. 19 and 20 show respectively, in a front view, the front and back of another example of a security element 1 of the invention.

In this example, the security element 1 comprises, on its front, an optical structure 4 consisting of a plurality of optical substructures, particularly having a rectangular shape, whereof the major side is parallel to the major side of the security element 1. The substrate 6 may bear, between the optical substructures, one or more reference patterns (not shown).

The optical structure 4 does not extend from one edge to the other of the security element 1 along its width. In this way, the security element 1 has two border zones 20a and 20b.

The border zones 20a and 20b are for example covered with an adhesive 14. The adhesive 14 may also be applied between the optical substructures, as shown in FIG. 19.

The border zones 20a and 20b may or may not comprise one or more security elements as described above.

On the back face, as shown in FIG. 20, the security element 1 may be completely covered with an adhesive 14.

The substrate 6 of the security element 1 may or may not comprise one or more comparison patterns (not shown) so that the optical structure is superimposed on the comparison pattern(s). The comparison pattern or patterns may be borne by the front and/or back face of the substrate 6 of the security element 1.

The width 1 of the border zones 20a and 20b is for example between 1 and 2 mm, for example equal to 1.5 mm.

The width L of the central zone of security element 1 bearing the optical structure 4 is for example between 3 and 4 mm.

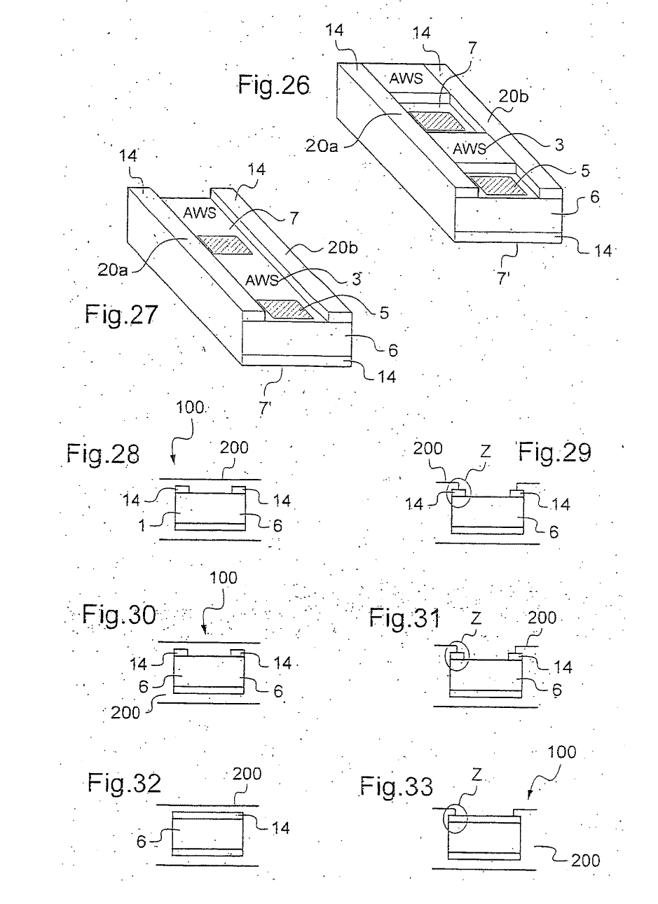

FIGS. 26 and 27 show another example of a security element in which the border zones 20a and 20b are covered with adhesive.

In the example in FIG. 26, adhesive bridges extend above the face 7 of the substrate, for example at the places on the face 7 where the reference patterns 3 are positioned. These reference patterns 3 may then be observable through the adhesive bridges.

In the example in FIG. 27, the face 7 of the substrate 6 is only covered with adhesive 14 at the border zones 20a and 20b.

As shown in FIGS. 26 and 27, the adhesive 14 may be placed on the border zones along the whole length of the thread.

FIGS. 28 to 33 show a schematic cross section of an object 100 in which a security element 1 according to FIG. 26 or 27 is incorporated.

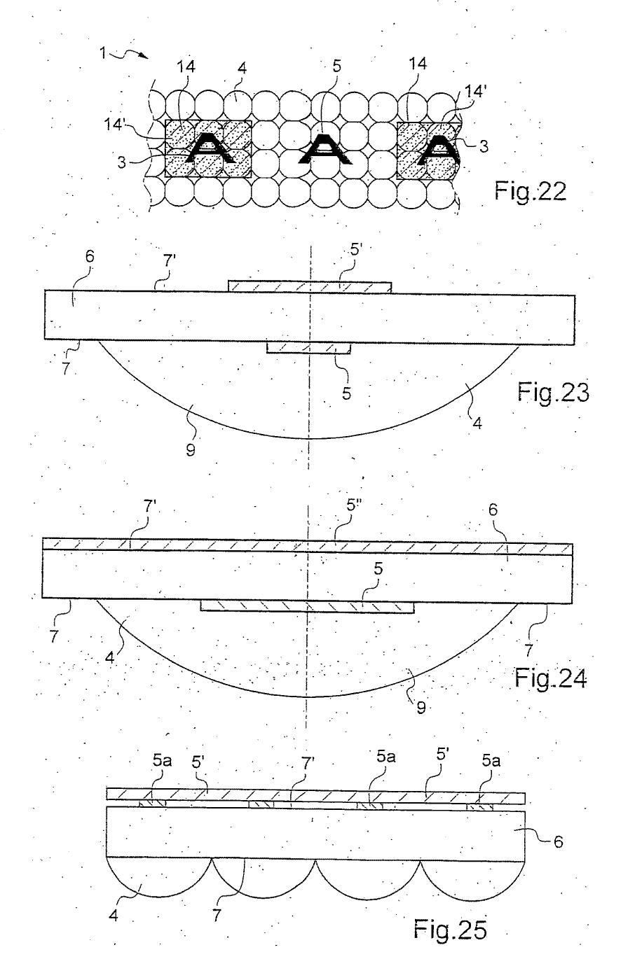

In the examples in FIGS. 29, 31 and 33, the security element 1 is incorporated in a window made in a fibrous base 200 of the object 100. The edges of this window form an overlap zone Z between the fibrous base 200 and the adhesive 14. This overlap zone may extend along the whole window and thereby allow the bonding of the fibers of the fibrous base 200 to the security element along the whole length of the window. FIGS. 21 and 22 show respectively, in cross section and in a front view, another example of a security element 1 of the invention.

In this example, the security element 1 comprises a substrate 6 on a face 7′ of which an optical structure 4 appears completely covering said face 7′. The optical structure 4 is formed by non-disjointed optical substructures.

The face 7, opposite the face 7′ bearing the optical structure 4, bears reference patterns 3 and comparison patterns 5.

The optical structure 4 is partially covered by an inactivation varnish 14′ which is superimposed on the reference patterns 3.

The inactivation varnish 14′ is advantageously a varnish nullifying the optical effect or effects of the optical structure 4. The observation of the reference patterns 3 through the optical structure 4 covered with the inactivation varnish 14′ corresponds to the direct observation that would be made of the reference patterns 3 without the presence of the optical structure 4. In this way, the optical structure 4 only preserves its optical effects in the zones not covered by the inactivation varnish 14′, particularly the zones superimposed on the comparison patterns 5.

The inactivation varnish 14′ may be selected to have a refractive index that serves to nullify the optical effects obtained by the optical structure 4. The refractive index of the inactivation varnish 14′ may for example be the same as that of the optical structure, particularly of the zone of the optical structure 4 to which the inactivation varnish 14′ is applied.

The outer surface Sₑ of the inactivation varnish 14′ is advantageously planar.

In FIG. 22, the image of the comparison pattern 5 shown corresponds for example to the enlargement of the comparison pattern 5 borne by the substrate 6 due to the observation through the optical structure 4. As to reference pattern 3, it is shown at scale 1:1 and may, for example, have the dimensions of the comparison pattern 5 after magnification. In fact, the observation through the optical structure 4 of the reference pattern 3 does not produce any effect on this pattern, particularly no magnification, due to the nullification of the optical effects by the inactivation varnish 14′.

Also in this example, the face 7 of the substrate 6 is completely covered with an adhesive 14, particularly a heat seal varnish. The adhesive 14 is also applied to the inactivation varnish 14′ covering the optical structure 4 borne by the face 7′ of the substrate 6.

The presence of the adhesive 14 on the face 7′ of the substrate 6 only covering the zones of the optical structure 4 covered by the inactivation varnish 14′ may serve to avoid damaging the optical observation properties of the optical structure 4 in the zones not covered by the inactivation varnish 14′, particularly the zones of the optical structure 4 superimposed on the comparison patterns 5.

Alternatively, the adhesive 14 could be an inactivation varnish and accordingly, the inactivation varnish 14′ could be omitted, the optical structure 4 only being partially covered by the adhesive 14 having a property of inactivating the optical effects of the optical structure 4.

FIGS. 23 to 25 show a schematic and partial view of other exemplary embodiments of security elements 1 of the invention.

In the example in FIG. 23, the substrate 6 bears on its face 7 a comparison pattern 5, and on its face 7′ a secondary comparison pattern 5′. As described above, the respective images of the comparison patterns 5 and 5′ thus appear to the observer's eye at different distances, thereby creating an effect of volume and depth.

In the example in FIG. 24, the substrate 6 bears on one of its faces 7 a comparison pattern 5 and on the other of its faces 7′ an additional pattern 5″.

The comparison pattern 5 and the additional pattern 5″ thus produced may make it possible to observe at least one of the images of the comparison pattern through the optical structure 4 and the additional pattern 5″ unaffected by the optical structure in different planes. The additional pattern 5″ is not affected by the optical structure, for example due to its distance from the optical structure and/or due to its large dimension with regard to the elementary optical structure or not. In particular, the additional pattern 5″, although placed in a more distant plane from the observer than the comparison pattern 5, may appear in the foreground.

In the example in FIG. 25, the substrate 6 bears on its face 7 a comparison pattern 5 consisting of a plurality of elementary comparison patterns 5a.

An additional pattern 5″ is formed on the comparison pattern 5 and has larger dimensions than the elementary comparison patterns 5a so that only the observation of the elementary comparison patterns 5a is affected by the optical structure 4. The additional pattern 5″ may appear as a background on which the image of the elementary comparison patterns 5a is observed through the optical structure 4. Similarly to the above, at least one of the images through the optical structure 4 of the elementary comparison patterns 5a and the additional pattern 5″ appear in different planes.

The expression “comprising one” must be understood as being synonymous with “comprising at least one”, unless otherwise specified.

1. A security element which, prior to the incorporation thereof into an object, comprises a substrate bearing at least:
an optical structure producing at least one image of at least one comparison pattern and/or producing image points of a light source illuminating the optical structure,
a reference pattern,
the optical structure and the reference pattern being borne by the substrate in order to allow the simultaneous observation of an image provided by the optical structure and of the reference pattern,
the image provided by the optical structure substantially corresponding to the reference pattern or being a complementary image of the reference pattern.

2. A security element which, prior to the incorporation thereof into an object, comprises a substrate bearing at least:
an optical structure producing at least one image of at least one comparison pattern and/or producing image points of a light source illuminating the optical structure,
a reference pattern,
the optical structure and the reference pattern being borne by the substrate in order to allow the simultaneous observation of an image provided by the optical structure and of the reference pattern,
the security element being a security thread and the optical structure extending only partially over the width of the security thread so that the substrate of the security thread has at least one border zone not covered by the optical structure.

3. The security element as claimed in claim 2, comprising an adhesive, the adhesive being borne by each face of the substrate.

4. The security element as claimed in claim 3, the face of the substrate bearing the optical structure comprising an adhesive on the zones of said face not covered by the optical structure, the optical structure being devoid of adhesive on its surface.

5. The security element as claimed in claim 1, the optical structure focusing the light in image points, the image provided by the optical structure resulting from the focusing at the image points of at least one light source illuminating the optical structure.

6. The security element as claimed in claim 1, the substrate bearing at least one comparison pattern whereof the optical structure provides an image.

7. The security element as claimed in claim 6, comprising at least two comparison patterns located at different distances from the optical structure.

8. The security element as claimed in claim 6, the optical structure producing an enlarged image of the comparison pattern.

9. The security element as claimed in claim 6, the optical structure producing an image that changes according to the angle of observation, an image whose dimensions are variable, or an appearing and disappearing image, of the comparison pattern.

10. The security element as claimed in claim 1, the optical structure extending only partially on the substrate.

11. The security element as claimed in claim 1, the optical structure being discontinuous.

12. The security element as claimed in claim 1, the substrate bearing the optical structure and the reference pattern on the same face.

13. The security element as claimed in claim 2, the security thread having a width that is greater than or equal to 4 mm.

14. The security element as claimed in claim 2, said at least one border zone being covered with an adhesive a heat seal varnish.

15. The security element as claimed in claim 1, the optical structure being partially covered with at least one inactivation varnish nullifying the optical effect or effects obtained by the optical structure.

16. The security element as claimed in claim 15, the inactivation varnish being superimposed on one or more reference patterns borne by the substrate.

17. An object incorporating a security element as claimed in claim 1.

18. A method for authenticating or identifying an object as claimed in claim 17, in which the reference pattern and the image provided by the optical structure are observed simultaneously, and information concerning the identity or authenticity of the object is determined at least from said observation.

19. The security element of claim 6, the image being a comparison pattern superimposed on the optical structure.

20. The security element of claim 11, the optical structure consisting of a set of disjointed elementary optical structures.

21. The security element of claim 14, the adhesive being a heat seal varnish.

22. The security element of claim 16, the one or more reference patterns being borne by the face of the substrate opposite the face bearing the optical structure.

23. The object of claim 17, being a security document.
